(19) United States
(12) Patent Application Publication
(10) Pub. No.: US 2005/0194498 A1
(43) Pub. Date: Sep. 8, 2005

(54) Apparatus and method for mounting a flat panel display

(75) Inventors: Don R. Burns, Tustin Ranch, CA (US); John Silva, Cypress, CA (US); Glenn Hamilton, Huntington Beach, CA (US)

Correspondence Address: FULBRIGHT AND JAWORSKI LLP, 555 S. FLOWER STREET, 41ST FLOOR, LOS ANGELES, CA, 90071, US

(73) Assignee: VANTAGE POINT PRODUCTS CORP.

(21) Appl. No.: 11/031,523

(22) Filed: Jan. 6, 2005

Related U.S. Application Data
(60) Provisional application No. 60/535,029, filed on Jan. 7, 2004.

(51) Int. Cl. F16L 3/00

(52) U.S. Cl. 248/121

(57) ABSTRACT

A mounting apparatus comprising a surface fixture, at least one support arm coupled to the surface fixture, and a display bracket. The display bracket is hingedly coupled to the support arm and is adapted to be affixed to a flat panel display. The display bracket is pivotable, relative to the support arm, between a closed position and an open position and is biased toward the closed position.

### BACKGROUND OF THE INVENTION

1. Priority

Priority is claimed to U.S. provisional application Ser. No. 60/535,029, filed Jan. 7, 2004. The disclosure of this priority document is incorporated herein by reference.

2. Field of the Invention

The field of the present invention is devices and method of mounting flat panel displays to vertical surfaces.

3. Background

Devices for mounting flat panel displays to vertical surfaces, such as walls, should serve two important functions. First, the device should facilitate mounting of flat panel display to the wall or other vertical surface. Second, the device should facilitate access to the rear of the flat panel display, where cables that provide power and video to the display are connected, without requiring removal of the display from the surface to which it is mounted. Much of the prior art fails to meet one or both of these two criteria.

### SUMMARY OF THE INVENTION

The present invention is directed towards an apparatus and method for mounting a flat panel display. The apparatus comprises a surface fixture, at least one support arm coupled to the surface fixture, and a display bracket. The display bracket is adapted to be affixed to a flat panel display and is hingedly coupled to the support arm. Optionally, one end of the display bracket may be hingedly coupled to an end of the support arm. The display bracket is pivotable, relative to the support arm, between an open position and a closed position. The display bracket may be optionally biased toward the closed position, and when the display bracket is in the closed position, it is preferably substantially parallel to the support arm. As an additional option, the surface fixture includes a mounting bracket and a rail affixed to the mounting bracket, with the support arm coupled to the rail.

The method comprises separately affixing the surface fixture to a vertical surface and affixing the display bracket, which is hingedly coupled to the support arm, to the flat panel display. Next, the support arm is suspended from the surface fixture. The flat panel display is thereafter pivoted away from the vertical surface. Finally, the support arm is secured to the surface fixture.

Accordingly, the present invention provides an improved apparatus and method for mounting a flat panel display. Other objects and advantages will appear hereinafter.

### BRIEF DESCRIPTION OF THE DRAWINGS

In the drawings, wherein like reference numerals refer to similar components:

FIG. 1 is a side elevation view of a mounting apparatus;

FIG. 2 is a partially exploded view of the mounting apparatus of FIG. 1;

FIG. 3 is a partially exploded view of an alternative embodiment of a mounting apparatus;

FIG. 4 is a flow chart showing the process of securing a flat panel display to a surface using the mounting apparatus of FIG. 1;

FIG. 5 is a perspective view of the device of FIG. 1 shown with a wire frame representation of a flat panel display affixed thereto and in the vertical position; and

FIG. 6 is a perspective view of the device of FIG. 1 shown with a wire frame representation of a flat panel display attached thereto and in the horizontal position.

### DETAILED DESCRIPTION OF THE PREFERRED EMBODIMENTS

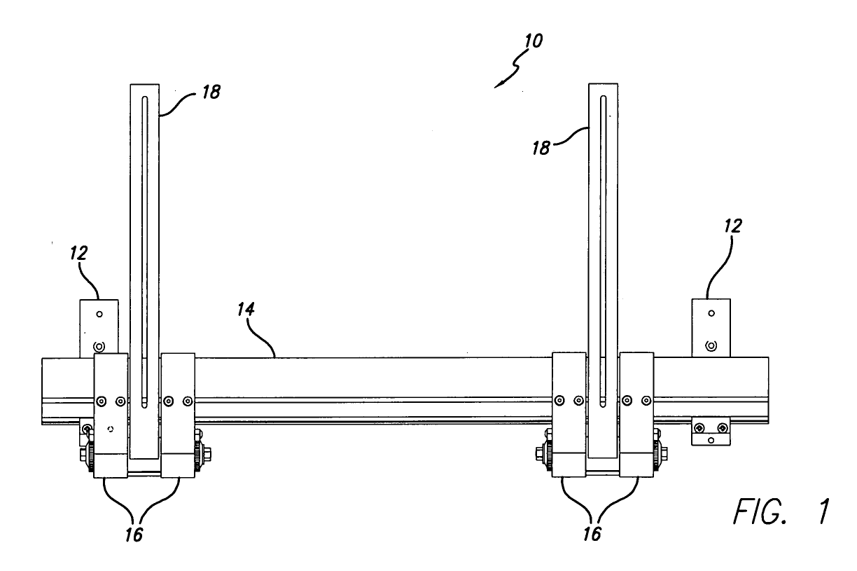

Turning in detail to the drawings, FIG. 1 illustrates a mounting apparatus 10 for a flat panel display (not shown), which advantageously allows the flat panel display to be mounted to a vertical surface such as a wall. The mounting apparatus 10 has a three-piece surface fixture, which includes two mounting brackets 12 and a rail 14 affixed to and extending between the mounting brackets 12. Four support arms 16 are secured to the rail 14. The support arms 16 are grouped in pairs, with each pair being hingedly coupled to a display bracket 18.

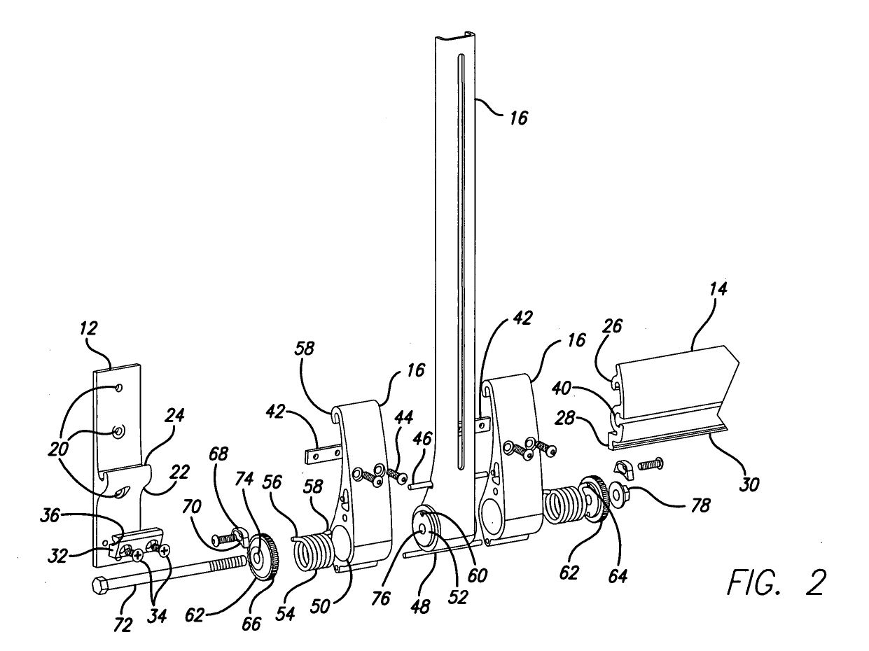

Referring to FIG. 2, the couplings between each of the various parts of the mounting apparatus are illustrated. The mounting bracket 12 includes holes 20 for affixing the mounting bracket 12 to a support surface (not shown) and an outward extending shoulder 22 which includes an upturned flange 24. The rail 14 includes a complimentary hooked flange 26 extending from the backside thereof. The shoulder 22 and flange 24 on the mounting bracket 16 engage and interlock the hooked flange 26 of the rail 14, such that rail 14 may be suspended from the mounting bracket 12 during installation. The rail 14 also includes a lower shoulder 28 with an outward extending flange 30 The rail 14 is further secured to the mounting bracket 12 by a cleat 32 that is directly secured to the mounting bracket 12 with two screws 34. The secured cleat 32 extends across the shoulder 28 and flange 30 of the rail 14 and includes a complementary groove 36 to receive and interlock with the flange 30.

The top of each support arm 16 has a hooked flange 38. This flange is extendable over the top edge of the rail 14, thereby enabling the support arms 16 to be suspended from the rail 14. The front side of the rail 14 includes a channel 40 to receive strips 42 for further securing the support arms 16 to the rail 14 using the screws 44.

The display bracket 18 is disposed between a pair of support arms 16. Two pins 46, 48 extend between the support arms 16, one pin 46 above and one pin 48 below the hinged connection with the display bracket 18, to help maintain the positioning of the two support arms 16 relative to each other. Each support arm 16 includes a cylindrical cavity 50 into which a raised shoulder 52 on the display bracket 18 is inserted. The cylindrical cavity 50 also houses a spring 54. Each end 56, 58 of the spring is bent in an axial direction. One end 58 of the spring 54 is inserted into a hole 60 appropriately positioned in the display bracket 18. A cap 62 is placed over the cylindrical cavity 50 to enclose the spring 54 therein. The other end 56 of the spring 54 is inserted into a hole 64 the cap 62. The cap 64 also has a ridged outer surface 66 around its perimeter. A brake 68 is affixed to the support arm 16 near the edge of the cap 62. The brake 68 includes a complementary ridged surface 70 to maintain the rotational position of the cap 62 relative to the support arm 16. A hinge pin 72 passes through an axial hole 74 in the cap 62, through the center of each spring 54, through an axial hole 76 in the display bracket 18, and is secured, after passing through the second support arm 16 and cap 62, with a threaded nut 78. Configured in this manner, the springs 54 bias the display bracket 18 in an upright or vertical position that is substantially parallel with the support arms 16.

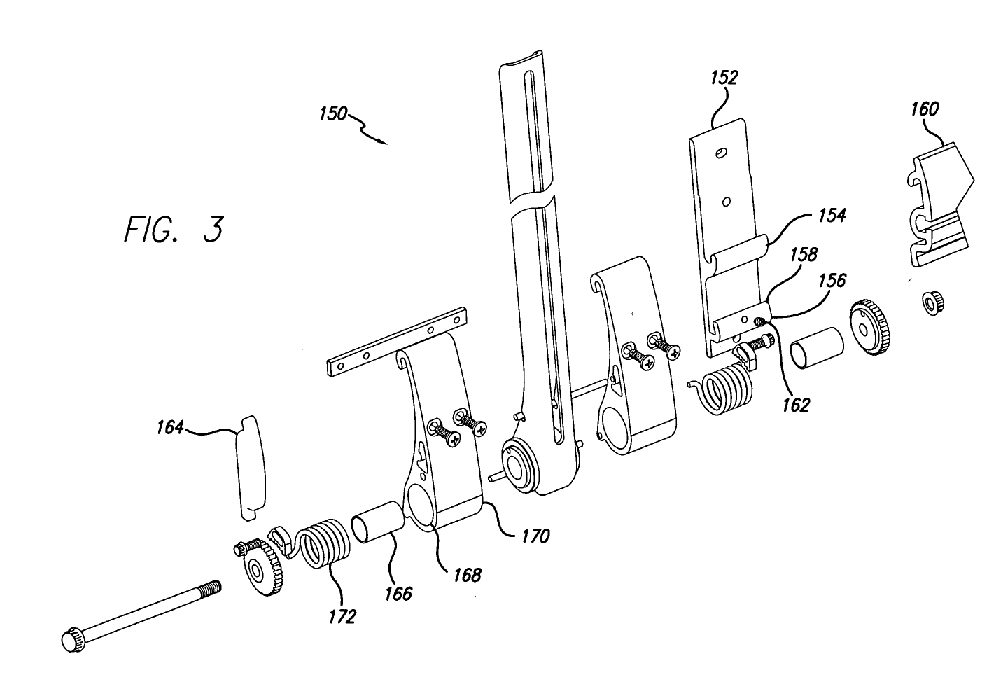

FIG. 3 illustrates some optional modifications that may be made to a mounting apparatus. This embodiment of the mounting apparatus 150 includes mounting brackets 152 which have an upper shoulder 154 and a lower shoulder 156. The upper shoulder 154 is formed as previously discussed in relation to the embodiment shown in FIG. 3. The lower shoulder 156 includes an upturned flange 158 which is formed to receive the lower edge of the rail 160. With the lower edge of the rail 160 engaging the lower shoulder 156 and the upturned flange 158, the rail is secured to the mounting bracket 152 using a set screw 162. Other additions to this embodiment of the mounting apparatus 150 include an end cap 164 which is placed over the ends of the rails to cover potentially sharp edges. Finally, a cylinder 166 is inserted into cylindrical cavity 168 of the support arm 170 to help maintain the positioning and shape of the spring 172.

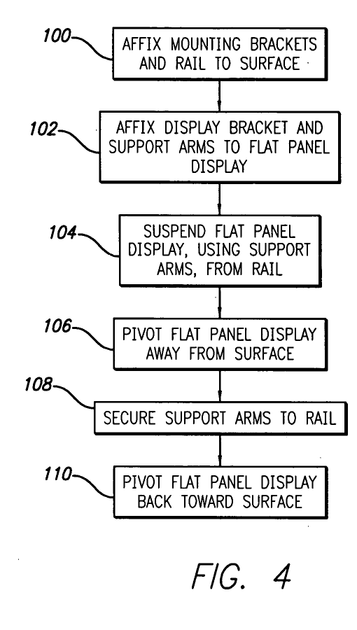

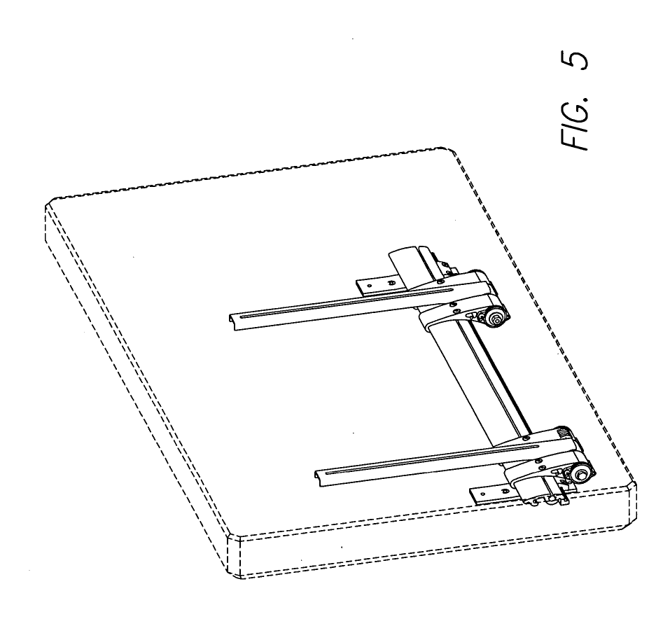

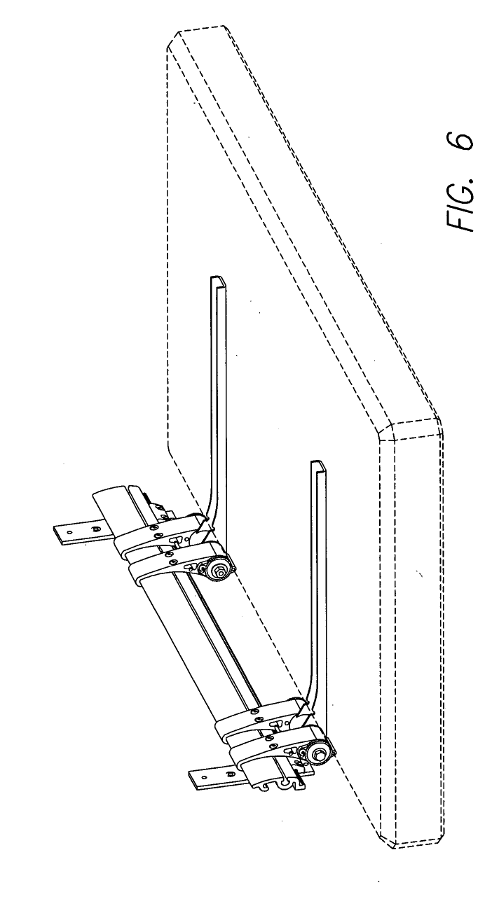

Referring to FIG. 4, when affixing a flat panel display to a vertical surface, the mounting brackets and the rail are affixed 100 to the surface, such as a wall, and the display bracket and the support arms are separately affixed 102 to the flat panel display. Next, the flat panel display is suspended 104 from the rail by placing the hooked flange at the top of each support arm over the top of the rail. At this point, the flat panel display and mounting apparatus will be as shown in FIG. 5, with the flat panel display being in a vertical position. Next, the flat panel display is pivoted downward 106 to the position shown in FIG. 6, which is horizontal or nearly horizontal. With the flat panel display in this horizontal position, the support arms are secured 108 to the rail as is shown above in FIG. 2. Also, power, video, and audio cables may be connected when the rear of the flat panel display is conveniently exposed by pivoting the flat panel display away from the surface to which it is mounted. Finally, the flat panel display is pivoted 110 back to the vertical position where it is ready for use.

Thus, a device and method for mounting a flat panel display are disclosed. While embodiments of this invention have been shown and described, it will be apparent to those skilled in the art that many more modifications are possible without departing from the inventive concepts herein. The invention, therefore, is not to be restricted except in the spirit of the following claims.

1. A mounting apparatus comprising:
a surface fixture;
at least one support arm coupled to the surface fixture;
a display bracket hingedly coupled to the at least one support arm, the display bracket being adapted to be affixed to a flat panel display, wherein the display bracket is pivotable, relative to the at least one support arm, between a closed position and an open position and is biased toward the closed position.

2. The mounting apparatus of claim 1, the support arm including a hooked flange at a first end thereof and being coupled to the display bracket at a second end thereof, wherein the hooked flange is adapted to engage the surface fixture.

3. The mounting apparatus of claim 2, wherein an end of the display bracket is hingedly coupled to the second end of the support arm.

4. The mounting apparatus of claim 1, wherein the display bracket is substantially parallel with the support arm when in the closed position.

5. The mounting apparatus of claim 1, wherein the at least one support arm is removably coupled to the surface fixture.

6. The mounting apparatus of claim 1, wherein the surface fixture comprises:
a mounting bracket; and
a rail affixed to the mounting bracket, wherein the support arm is coupled to the rail.

7. The mounting apparatus of claim 6, wherein the mounting bracket includes a support flange adapted to engage the rail.

8. A mounting apparatus comprising:
a surface fixture;
a display bracket adapted to be affixed to a flat panel display;
a support arm including a hooked flange at a first end thereof and being hingedly coupled to an end of the display bracket at a second end thereof, wherein the hooked flange is adapted to engage the surface fixture.

9. The mounting apparatus of claim 8, wherein the at least one support arm is removably coupled to the surface fixture.

10. The mounting apparatus of claim 8, wherein the surface fixture comprises:
a mounting bracket; and
a rail affixed to the mounting bracket, wherein the support arm is coupled to the rail.

11. The mounting apparatus of claim 10, wherein the mounting bracket includes a support flange adapted to engage the rail.

12. A mounting apparatus comprising:
a mounting bracket;
a rail affixed to the mounting bracket;
two display brackets adapted to be affixed to a flat panel display;
four support arms, each support arm including a hooked flange at a first end of the support arm and each being hingedly coupled to an end of one of the display brackets at a second end of the support arm, each display bracket being coupled to two of the support arms, wherein the hooked flange of each support arm is adapted to suspend the support arm to the rail, and the display bracket is pivotable, relative to each coupled support arm, between a closed position and an open position, the display bracket being biased toward the closed position.

13. The mounting apparatus of claim 12, wherein the display bracket is substantially parallel with the support arm when in the closed position.

14. A mounting apparatus comprising:
a surface fixture;
at least one support arm including a means to removably couple the support arm to the surface fixture;
a display bracket hingedly coupled to the at least one support arm, the display bracket being adapted to be affixed to a flat panel display, wherein the display bracket is pivotable, relative to the at least one support arm, between a closed position and an open position, and includes a means to bias the display arm toward the closed position.

15. The mounting apparatus of claim 14, wherein the surface fixture comprises:
a mounting bracket; and
a rail affixed to the mounting bracket, wherein the support arm is coupled to the rail.

16. The mounting apparatus of claim 14, wherein the mounting bracket includes means to engage the rail.

17. The mounting apparatus of claim 14, wherein the display bracket is substantially parallel with the support arm when in the closed position.

18. A method of mounting a flat panel display to a vertical surface, the method comprising:
affixing a surface fixture to the vertical surface;
affixing a display bracket to the flat panel display, the display bracket being hingedly coupled to a support arm; then
suspending the support arm from the surface fixture; then
pivoting the flat panel display away from the vertical surface; and then
securing the support arm to the surface fixture.

19. The method of claim 18, wherein the display bracket is hingedly coupled to the support arm near an edge of the flat panel display.

20. The method of claim 18, wherein the display bracket is pivotable, relative to the support arm, between a closed position and an open position and is biased toward the closed position.

21. The method of claim 20, wherein the display bracket is substantially parallel with the support arm when in the closed position.

22. A method of mounting a flat panel display to a vertical surface, the method comprising:
affixing a surface fixture to the vertical surface, the surface fixture including a support flange;
affixing a display bracket to the flat panel display, the display bracket being hingedly coupled to a support arm near an edge of the flat panel display, wherein the display bracket is pivotable, relative to the support arm, between a closed position and an open position and is biased toward the closed position; then
suspending the support arm from the support flange; then
pivoting the flat panel display away from the vertical surface; and then securing the support arm to the surface fixture.

23. The method of claim 22, wherein the display bracket is substantially parallel with the support arm when in the closed position.
